(19) United States
(12) Patent Application Publication
(10) Pub. No.: US 2026/0243334 A1
(43) Pub. Date: Aug. 20, 2026

(54) MECHANICAL DEVICE FOR CONNECTING RODS, LEVERS AND PISTONS

(71) Applicant: Marcial Jorge PARRILLA CABRERA, TIAGUA-TEGUISE (ES)

(72) Inventor: Marcial Jorge PARRILLA CABRERA, TIAGUA-TEGUISE (ES)

(21) Appl. No.: 19/160,503

(22) PCT Filed: Jan. 25, 2024
(86) PCT No.: PCT/ES2024/070042

§ 371 Date: Aug. 28, 2025

(30) Foreign Application Priority Data
Mar. 3, 2023 (ES) U202330344

(51) Int. Cl. F16H 21/18

(52) U.S. Cl. CPC F16H 21/18

(57) ABSTRACT

Mechanical linkage device consisting of connecting rods, levers and pistons, featuring a support structure with shafts, crankshafts, connecting rods, crankpins, and levers connected to each other to, by applying a rotational movement of a determined torque on a primary shaft, obtain on a secondary shaft a rotational movement of the same angular speed with amplified torque.

The present invention pertains to a mechanical transmission system featuring connecting rods, levers, and pistons designed for multiple uses across various assemblies, demonstrating an increase in torque.

### OBJECTIVE OF THE CURRENT INVENTION

The goal of this experiment is to transfer a 360-degree rotational movement, along with its torque generated by an external agent, into a linear movement, utilising well-known systems such as the lever. This lever increases torque through differences in length and pivot, resulting in enhanced torque that can be transferred to pistons or used as a 360-degree rotational movement. However, given its distance from the origin, we reconvert this rotational movement, with the now increased torque, into linear motion and transfer it to another lever, which once again amplifies the previously increased torque. From here, it can be directed to pistons or converted into another 360-degree rotational movement, allowing for a return to the start and repetition as many times as desired. It is recommended to distribute the rotational movement of the input shaft into several linear forces to achieve a distribution of the torque, and simultaneously ensure that when transferring the linear movement to a shaft, there are no dead angles in its 360-degree rotation. Through this method, a greater distribution and performance of the torque in the 360-degree rotation of the output shaft is achieved, along with an input speed equal to the output speed.

### BACKGROUND OF THE INVENTION

At present, the technical theory of torque-force variation is known, which is useful in the theoretical study of associated techniques. However, often the simple physical experimentation of these principles could be more intuitive or easier to understand.

Moreover, in the experimentation itself to find technical solutions or efficiencies in the variation or transformation of torque forces, it is also useful to have a model where potential results can be physically appreciated and subsequently transferred to real models.

To the applicant's knowledge, there is no known device or mechanism similar to the one proposed in this invention.

### DESCRIPTION OF THE INVENTION

The mechanical device of the invention comprises:
a support or casing, where the following are supported:
a first primary shaft by which rotational input movement is introduced,
a first crankshaft connected to the primary shaft,
first connecting rods of equal length, articulated to a crankpin on the first crankshaft, in a joint situated at a distance D1 from the geometric centre of the primary shaft,
first levers of equal length, each one attached to the free end of one of the first connecting rods by means of joints, and in turn connected to the support articulated at distance D6 through joints and positioned at a shorter distance D5, with distance D6 being greater than distance D5,
second connecting rods, each connected to the distal end of the first levers via joints, and each of them articulated at its opposite end to the second crankpins of second crankshafts or to a piston per connecting rod,
second crankshafts, with second crankpins situated at a distance D2 from the second shafts,
second shafts, connected to the second crankshafts and on the other side connected to the third crankshafts.
third crankshafts, with third crankpins at a distance D3
third connecting rods of equal length, each one of them articulated at its proximal end to the third crankpins of the third crankshafts,
second levers of equal length, connected to the free ends of the third rods through joints, and in turn attached to the support at a distance D8 via joints positioned at a shorter distance D9 from their distal end,
Fourth connecting rods of equal length, each connected at its distal end to the second levers through joints, and each articulated at its opposite end to the second crankpin of a fourth crankshaft or to a piston for each fourth connecting rod.
a fourth crankshaft, with a fourth crankpin at a distance D4 from the geometric centre of the secondary shaft.

A third shaft, the secondary shaft, connected to the fourth crankshaft,

In this manner, by applying a specific rotational torque to the primary shaft, variations in this torque are obtained at each joint, resulting in the secondary shaft displaying rotational motion at the same angular velocity but with amplified torque, gaining in force. It is possible to observe the changes in velocity and amplitude of the movements across all intermediate elements, and even measure them using suitable instruments, which are not the focus of the present invention.

### BRIEF DESCRIPTION OF THE DRAWINGS

FIGS. 1 and 2 show a front view of the device in the invention in two rotational phases.

FIGS. 3 and 4 show a rear view of the device in the invention in two rotational phases.

FIG. 5 shows a plan view of the device in the invention.

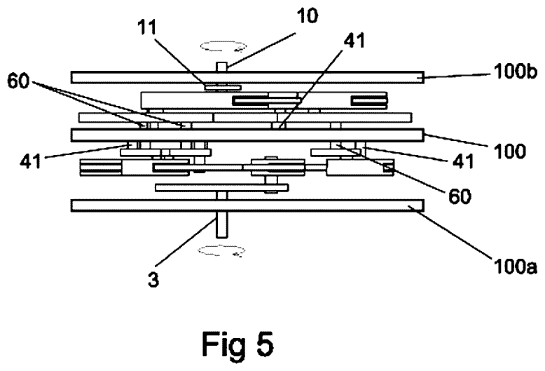

### DESCRIPTION OF A PRACTICAL REALISATION OF THE INVENTION

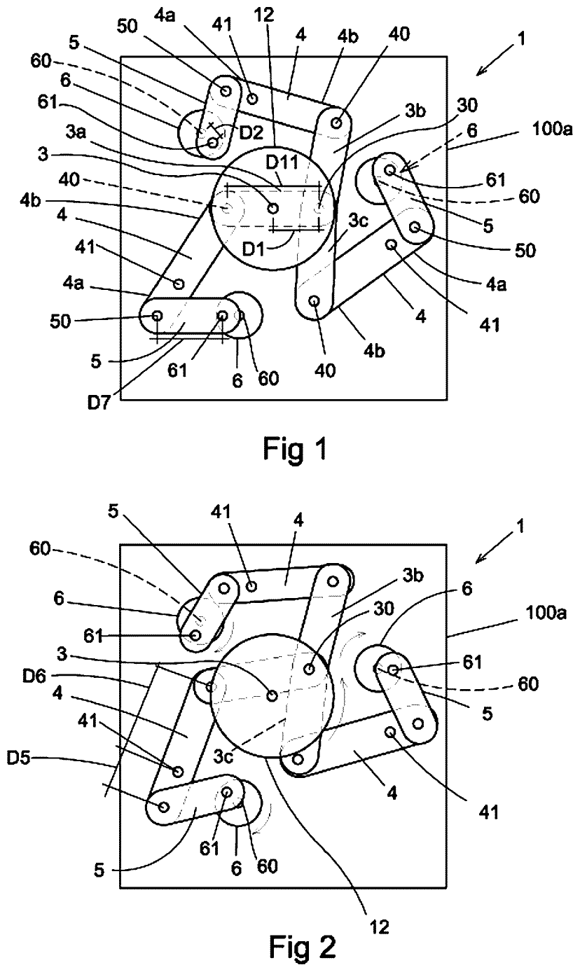

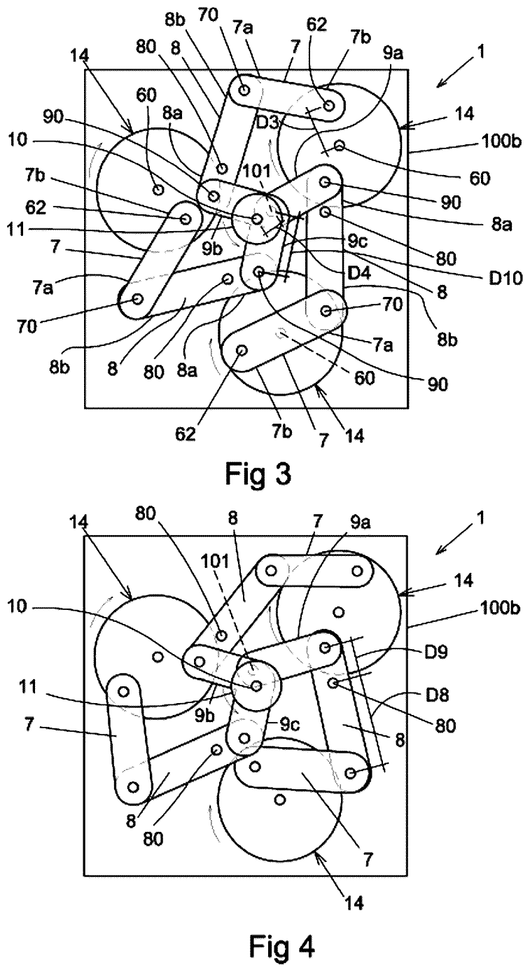

The mechanical device (1) of connecting rods and levers according to the invention comprises (see FIGS. 1 and 2):
a support, where a first joint is located and it supports:
a primary shaft (3) through which a rotational input movement is introduced, connected to a first crankshaft (12),
where the first crankshaft (12) has a crankpin (30) situated at a distance D1 from the geometric centre of the primary shaft's (3) connection to the first crankshaft (12),
three first connecting rods (3a, 3b, 3c), articulated at the crankpin (30), of equal length,
three first levers (4), of equal dimensions, each of them connected to the free end of one of the three first connecting rods (3a, 3b, 3c) by means of three third joints (40), which are in turn connected to the support at a distance D6 via three fourth joints (41), arranged at a shorter distance D5 from their distal end (4a) in relation to the transmission of movement from their proximal end (4b), with D6 being greater than D5, and the greater D6 is, the greater the torque will be.
three second connecting rods (5), of identical dimensions with a minimum length equal to D5, each connected to the distal end (4a) of one of the first levers (4) through three fifth joints (50), and each articulated at the sixth joint by its opposite end to second crankpins (61) of the second crankshafts (6) or to a piston, for each second connecting rod,
the three second crankshafts (6), with second crankpins (61) positioned at a distance D2 from the geometric centre of the joint of their second shafts (60), with D2 being half of D5,
the three second shafts (60), secured in a way in which they can be articulated within the housing, support the second crankshafts (6) at one end and extend to the other end into third crankshafts (14) (see FIGS. 3 and 4) forming a single piece,
the three third crankshafts (14) (see FIGS. 3 and 4), with third crankpins (62) positioned at a distance D3 from the geometric centre of the second shaft joint (60),
three third connecting rods (7), each articulated at its proximal end (7b) via the third crankpin (62) in an eighth joint on the third crankshaft (14),
three second levers (8), of equal size, connected to the distal end (7a) of the third connecting rods (7) via a ninth joint (70); in turn, they are attached to the support via three tenth joints (80), positioned at a distance D8 from their proximal end (8b), which is greater than the distance D9 to their distal end (8a) concerning the transmission of motion, with D8 being greater than D9.

The greater D8 is, the greater the torque will be, and D3 is half of D8.
three fourth connecting rods (9a, 9b, 9c) of equal dimensions, connected to the distal end (8a) of the second levers (8) via eleven joints (90), at a distance D10, which must be equal to or greater than D9, and simultaneously connected by their free end to the twelfth joint on the crankpin (101) of a fourth crankshaft (11) or to a piston for each connecting rod,
the fourth crankshaft (11), which is supported and connected to the secondary shaft (10), with the crankpin (101) situated at a distance D4 from the geometric centre of a secondary shaft (10) (see FIGS. 3 and 4), with the distance D4 being half that of D9,
the secondary shaft (10), articulated to the support at a thirteenth joint, and forming a single assembly with the fourth crankshaft (11).

It is preferred that the support comprises three parallel vertical plates (100a, 100b, 100): a first lateral plate (100a) where the primary shaft (3) is supported, a second lateral plate (100b) where the secondary shaft (10) is supported, and a central plate (100) where the fourth joints (41), the second crankshaft axes (60), and the tenth joints (80) are supported.

The device (1) can also comprise several stages. Furthermore, in this instance, the second lateral plate from the previous stage can indefinitely coincide with the first lateral plate of the next stage, according to requirements. In this way, a greater amplification of torque variation is achieved at each stage.

In this preferred example, the device comprises a primary shaft (3), a first crankshaft (12), three first connecting rods (3a, 3b, 3c), three first levers (4), three second connecting rods (5), three second crankshafts (6), three second shafts (60), three third crankshafts (14), three third connecting rods (7), three second levers (8) and three fourth connecting rods (9a, 9b, 9c), and a fourth crankshaft (11) and an output secondary shaft (10), which can alternatively comprise 1, 2, 4, or 5 identical sets of these components. By primarily varying the distance of the levers (4, 8), each set achieves a variation in torque.

Furthermore, one of the first connecting rods (3a) can be free, while the other two first connecting rods (3b, 3c) can be fixed to form an angle between 160 degrees and 180 degrees. Similarly, one of the fourth rods (9a) can be free, and the other two fourth rods (9b, 9c) can be fixed to create an angle between 60 degrees and 135 degrees, as these parameters are expected to improve torque transmission.

Finally, it should be noted that the preferred distance D11 between the crankpin (30) and the second joint (40) is equal to D6 and is twice the distance D1 between the primary shaft and the crankpin (30). The distance D7 between the fifth joints (50) and the second crankpin (61) should be equal to or greater than D5, and the distance D10 should be equal to or greater than D9, with D2 being half of D5 and D4 being half of D9.

The rotational speed on the primary shaft (3) is equal to the rotational speed of the secondary shaft (10) in RPM, and the principle of the device can be expanded indefinitely in cascading stages.

Finally, the formula for the expected force gain of the device is provided:

$$W - R 1 = W 2 - R 2 = W 3 - R 3 = W 4 - R 4 = W 5 \times Z 1 = W 6 - R 5 = W 7 - R 6 = W 8 - R 7 = W 9 - R 8 = W 10 - R 9 = W 11 - R 10 = W 12 \times Z 2 = W 13 - R 11 = W 14 - R 12 = W 15 - R 13 = W 1$$

Where:
W=Power or torque of input force
R1=Resistance in the primary shaft (3).
W2, W3, W4, W5, W6, W7, W8, W9, W10, W11, W12, W13, W14, W15=Resultant powers.
R2=Resistance in the crankpin joint (30).
R3=Sum of the resistances at the third joints (40), as many as there are.
R4=Sum of the resistances at the fourth joints (41), as many as there are.
Z1=“Y” divided by “X” equals “Z”, where “X” is the distance between the fourth joints (41) and the fifth joints (50), and “Y” is the distance between the third joints (40) and the fourth joints (41).
R5=Sum of the resistances at the fifth joints (50), as many as there are.
R6=Sum of the resistances at the second joints (61) of each crankshaft, as many as there are.
R7=Sum of the joint resistances on the crankshaft pins (60), as many as there are.
R8=Sum of the joint resistances on the third crankpin (62) of each crankshaft, as many as there are.
R9=Sum of the joint resistances on the ninth joint (70), as many as there are.
R10=Sum of the resistances in the tenth joints (80), as many as there are.
Z2=“Y2” divided by “X2” equals “Z2”, where “X2” is the distance between the tenth joints (80) and the eleventh joints (90), and “Y2” is the distance between the ninth joints (70) and the tenth joints (80).
R11=Sum of the resistances at the eleventh joints (90), as many as there are.
R12=Resistance of the joints at the crankpin (101) of the fourth crankshaft.
R13=Resistance of the joints on the secondary shaft (10)
W2=Output power or torque.

When there are several stages, the formula would be expanded as many times as necessary.

The mechanical device can alter its operation by transferring the torque to one or more pistons, not depicted, for use with liquids, gases, and even air, rather than to a secondary shaft. The piston is connected to the joint (61) of the second connecting rods (5) or to the fourth connecting rod (9a, 9b, 9c) and the joint (101) as required, allowing for as many pistons as there are connecting rods, with a stroke corresponding to distance D5 at point (61) or distance D9 at point (101).

Having sufficiently described the nature of the invention, as well as its practical implementation in practice, it should be noted that the arrangements previously mentioned and depicted in the attached drawings are open to modifications of detail as long as they do not alter the fundamental principle.

1. Mechanical linkage device (1) consisting of connecting rods, levers and pistons, characterised by comprising:
a support where the following are supported:
a primary shaft (3) via which an input rotational movement is introduced,
a first crankshaft (12) connected to the primary shaft (3),
first connecting rods (3a, 3b, 3c) of equal length, articulated on a crankpin (30) located on the first crankshaft (12), positioned at a distance D1 from the geometric centre of the primary shaft (3),
a set of first levers (4), each of identical dimensions, with each connected to the free end of one of the three first rods (3a, 3b, 3c) via three third joints (40), which in turn are attached to the support at a distance D6 through three fourth joints (41), positioned closer at a distance D5 from its distal end (4a) in relation to the transmission of the movement from its proximal end (4b), where D6 is greater than D5,
second connecting rods (5), each of them connected to the distal end (4a) of one of the first levers (4) via fifth joints (50), and each of them articulated at its opposite end to pistons or to the second crankpin (61) of a second crankshaft (6), where each second crankshaft (6) is supported by a second crankshaft shaft (60) mounted on support 100, and the free end of the second shaft (60) supports a third crankshaft (14); where the second crankpins (61) are positioned at a distance D2 from the second shaft (60) of the second crankshaft (6), and with third crankpins (62) on the third crankshafts (14) at a distance D3 from the second axis (60), with the distance D3 being greater than the distance D2.
third connecting rods (7), each of them articulated at its proximal end (7b) to a third crankpin (62) of the third crankshafts (14),
second levers (8), connected to the distal end (7a) of the third connecting rods (7) via ninth joints (70), and in turn connected to the support via tenth joints (80) positioned at a distance D8 from its proximal end (8b) that is greater than the distance D9 to its distal end (8a) with respect to the transmission of movement, with D8 being greater than D9.
fourth connecting rods (9a, 9b, 9c) connected by one of their ends to the distal end (8a) of the second levers (8) via eleventh joints (90), and simultaneously connected at their free end to pistons or via articulated crankpins (101) located on the fourth crankshaft (11), with the crankpin (101) on the fourth crankshaft positioned at a distance D4 from the geometric centre of the secondary output shaft (10), where distance D4 is less than distance D1 and distance D3.

2. Mechanical linkage device (1) consisting of connecting rods, levers, and pistons according to claim 1, where the support comprises three vertical plates (100a, 100b, 100) that are parallel and held by a casing; including a first lateral plate (100a) which supports the primary shaft (3), a second lateral plate (100b) which supports the secondary shaft (10), and a central plate (100) that supports the fourth joints (41), the second crankshaft shafts (60), and the tenth joints (80).

3. Mechanical linkage device (1) consisting of connecting rods, levers and pistons according to claim 1, that comprises multiple stages.

4. Mechanical linkage device (1) consisting of connecting rods, levers, and pistons according to claim 1, that comprises a primary shaft (3), a first crankshaft (12), three first connecting rods (3a, 3b, 3c), three first levers (4), three second connecting rods (5), three second crankshafts (6), three second shafts (60), three third crankshafts (14), three third rods (7), three second levers (8), three fourth connecting rods (9a, 9b, 9c), a fourth crankshaft (11) and a secondary shaft (10).

5. Mechanical linkage device (1) consisting of connecting rods, levers, and pistons according to claim 4, where one of the first connecting rods (3a) is free and the other two first connecting rods (3b, 3c) are rigidly connected, forming an angle between 160 degrees and 180 degrees, and where one of the fourth connecting rods (9a) is free and the other two fourth connecting rods (9b, 9c) are rigidly connected, forming an angle between 60 degrees and 135 degrees.

6. Mechanical linkage device (1) consisting of rods, levers, and pistons according to claim 1, where the distance between the crankpin (30) and the second joint (40) is twice the distance D1 between the primary shaft (3) and the crankpin (30).
